(19) United States
(12) Patent Application Publication
(10) Pub. No.: US 2018/0169817 A1
(43) Pub. Date: Jun. 21, 2018

(54) METHOD AND DEVICE FOR REDUCING THE ENERGY DEMAND OF A MACHINE TOOL AND MACHINE TOOL SYSTEM

(71) Applicant: ZF Friedrichshafen AG, Friedrichshafen (DE)

(72) Inventors: Yiwen XU, Tiefenbach (DE); Herman YAKARIA, Langenargen (DE); Tobias KÖSLER, Friedrichshafen (DE); Thomas ACKERMANN, Ravensburg (DE); Johannes BAUER, Bergtheim (DE)

(21) Appl. No.: 15/738,217

(22) PCT Filed: May 24, 2016
(86) PCT No.: PCT/EP2016/061646

§ 371 Date: Dec. 20, 2017

(30) Foreign Application Priority Data
Jun. 26, 2015 (DE) 102015211941.6

(51) Int. Cl. B23Q 41/06; G05B 19/418; G05B 19/042; G05B 19/408; G05B 15/02

(52) U.S. Cl. CPC B23Q 41/06; G05B 19/41865; G05B 19/0426; G05B 2219/37478; G05B 15/02; G05B 2219/25289; G05B 2219/37033; G05B 19/4086

(57) ABSTRACT

A method for reducing an energy demand of a machine tool (2, 3, 4) of a machine tool system (1), wherein the machine tool system (1) comprises at least a first machine tool (3), with a first machine cycle time, and a second machine tool (4), with a second machine cycle time. Identical workpieces (9) are transported sequentially in time for processing (101, 107), first to the first machine tool (3) and then to the second machine tool (4). The second machine cycle time is shorter than the first machine cycle time. The method according to the invention is characterized in that the workpieces (9), after being processed by the first machine tool (3), are collected (105, 106) before they are conveyed (107) to the second machine tool (4) for processing. The invention also concerns a related device (10) and a machine tool system (1).

This application is a National Stage completion of PCT/EP2016/061646 filed May 24, 2016, which claims priority from German patent application serial no. 10 2015 211 941.6 filed Jun. 26, 2015.

### FIELD OF THE INVENTION

The present invention concerns a method for reducing the energy demand of a machine tool, a device for a machine tool system, and a machine tool system.

### BACKGROUND OF THE INVENTION

In the prior art it is known to equip production machinery and a production facilities with an energy-saving idle mode in which, when these units have been inactive for a long time, they can switch themselves off automatically. The availability of the idle mode in an ever-increasing number of production machines and production facilities is on the one hand motivated by the concept of environmental protection, particularly the reduction of CO₂ emissions. On the other hand, however, the idle mode also contributes toward the avoidance of unnecessary production costs since production machines and production facilities are characterized by a comparatively high energy demand. This is reflected in not to be underestimated energy costs, which drive up the manufacturing costs of a product and thereby reduce its competitiveness.

In this connection DE 11 2009 004 354 T5 discloses a system and a method for reducing an idling power outflow. In this case a machine has a plurality of electronic control devices, which are connected electrically to an electric power source on the one hand by way of a first electric switching circuit through a first relay and on the other hand by way of a second electric switching circuit through a second relay. A relay control device is connected to the electric power source by way of a third electric switching circuit and is at the same time in connection with the first and second relays. The relay control device is configured in such manner that it opens or closes the first relay or the second relay in accordance with a power demand indication. In this way an unnecessary power outflow in an idle mode of the machine can be avoided.

DE 10 2004 030 312 A1 discloses an electric tool control device for an electric tool. While the electric tool is working, the control device is acted upon by the full main voltage, whereas in the idle mode it is supplied with a considerably lower voltage. According to DE 10 2004 030 312 A1, in the idle mode the control device receives just enough voltage to enable it to carry out an idling function. The idling function can for example consist of the electric supply of a microcontroller or an electronic unit for regulating the rotational speed of the electric tool. This reduces the load on the control unit and improves the efficiency. Thus, the idle condition is an energy-saving mode of the electric tool, in which the power consumption of the electric tool is kept as low as possible when it is not being used for work.

However, the known devices and methods have the disadvantage that they focus exclusively on the energy demand of a single machine tool, without taking into account its incorporation into a system comprising a plurality of machine tools and in particular without taking account of its energetic synergy with the system. Thus, possible energy savings by virtue of a better matching of the machine tools with one another remain largely ignored.

### SUMMARY OF THE INVENTION

An objective of the present invention is to propose a better method for reducing the energy demand of a machine tool of a machine tool system.

According to the invention, this objective is achieved by the method for reducing the energy demand of a machine tool in accordance with the independent claim. Advantageous design features and further developments of the invention emerge from the dependent claims.

The invention concerns a method for reducing the energy demand of a machine tool of a machine tool system, wherein the machine tool system comprise at least one first machine tool with a first machine cycle time and a second machine tool with a second machine cycle time, wherein identical workpieces are supplied sequentially in time for processing, first to the first machine tool and then to the second machine tool, and wherein the second machine cycle time is shorter than the first machine cycle time. The distinguishing feature of the method according to the invention is that after having been processed by the first machine tool, the workpieces are collected before being sent on to the second machine tool.

Thus, the invention is based on the idea that after being processed by the first machine tool, which works comparatively more slowly and accordingly has the comparatively longer machine cycle time, the workpieces should not immediately be sent on to the second machine tool which works comparatively more quickly and therefore has the comparatively shorter machine cycle time. Instead, after having been processed by the first machine tool the workpieces are collected for a predeterminable time interval or until a predeterminable number of workpieces has been reached, before they are delivered together to the second machine tool.

Thus, the second machine tool which works comparatively more quickly is on the one hand in its working mode for a comparatively longer time duration, since it is not individual workpieces but the collected workpieces that are delivered to it. On the other hand, it is also in the idle mode for a comparatively longer time duration, while after being processed by the first machine tool the workpieces are collected together.

This has the advantage that the second machine tool does not have to be changed to the idle mode after the processing of each individual workpiece, and does not have to be changed back into working mode before the processing of each individual workpiece. Namely, both the change to the idle mode and the change to the working mode take a certain time, and in particular the change to the working mode can have a negative influence on the total processing time of a workpiece since a machine tool usually only begins changing from the idle mode to the working mode when a workpiece to be processed is supplied to it. Thus the situation may arise that a workpiece 9 is already in the machine tool but the machine tool has not yet finished changing to the working mode. Moreover, by avoiding the continual changing into the idle mode or the working mode the total time spent in the idle mode can be made longer. Since, furthermore, the energy demand or power demand of a machine tool in the idle mode is usually substantially lower than it is in the working mode, the energy or power demand of the second machine tool can be reduced without affecting the processing of the workpieces. In particular the total machining time for each workpiece by the machine tool system is not made longer, so the production cost is not increased.

In the context of the invention the terms “first machine cycle time” and “second machine cycle time” are understood to mean the time needed for the first or second machine tool to process a single workpiece. Thus, the first or second machine cycle time describe the throughput of the first or second machine tool per unit of time.

In the context of the invention the term “machine tool” is understood to mean any type of machine capable of processing a workpiece. For example, the machine tool can be designed to cast, file, mill, drill, lacquer or heat a workpiece.

In the context of the invention the term “idle or idling mode” is understood to mean an operating condition of a machine tool in which the machine tool deactivates part of its tool modules or secondary control units in order to reduce its energy or power demand.

In the context of the invention the term “working mode” is understood to mean an operating mode of the machine tool in which the machine tool processes workpieces and in which all the tool modules and secondary control units are activated.

In the context of the invention the term “secondary control unit” is understood to mean a sub-control unit designed to control a single tool module. The secondary control units are subordinate to the main control unit of the machine tool.

According to a preferred embodiment of the invention it is provided that the second machine tool changes to an idle condition when there are no workpieces in it for processing. Since the energy or power demand of the machine tool is comparatively lower in the idle mode than in the working mode, energy can be saved by changing the machine tool to the idle mode when in any case there are no workpieces to be processed.

In a particularly preferred embodiment of the invention it is provided that the idling mode is divided into a plurality of idling mode stages, such that when changing to the idle mode one of the plurality of idling mode stages is selected in accordance with an expected duration of the idle mode. Since, conversely, changing the machine tool back into its working mode takes a certain time that depends on the number and type of deactivated tool modules or secondary control units, it is possible in this way to advantageously select an idling mode stage that seems suitable in each case, with regard to the overall processing sequence and the total processing duration. In doing this, the longer the expected duration of the idle mode is, the more tool modules or secondary control units of the machine tool are preferably deactivated. For example the idle mode can have a so-termed basic mode stage, a so-termed secondary mode stage and a so-termed standby mode stage, each of the idling mode stages being characterized by an individual power demand of the machine tool. Usually, with increasing duration of the idle mode the machine tool deactivates an increasing number of tool modules or secondary control units in order to enable further energy or power savings, and thereby approaches stage by stage the standby mode stage, in which the power demand is as a rule lowest. For example, if the machine tool is a grinding machine for grinding gearwheel teeth, on entry into the idle mode it is possible first to switch directly into the secondary mode stage. In the secondary mode stage, at first only the drives of the spindle holding the gearwheel to be ground, and which move as required by the grinding process, are switched off. As the duration of the idling mode increases, the machine tool can change to the basic mode stage. In the basic mode stage the main spindle is deactivated and in addition the pneumatic and hydraulic components of the machine tool are switched off. Finally, if the idle mode lasts even longer the machine tool can change to the standby mode stage and switch off the cooling system and the electronic control system as well. Thus, during the idle mode the power demand of the machine tool is reduced in stages.

According to a further preferred embodiment of the invention it is provided that after being processed by the first machine tool, a specified number of workpieces are collected. This has the advantage that the expected duration of the idle mode of the second machine tool can be predetermined very accurately with reference to the difference between the first machine cycle time, the second machine cycle time and the specified number of workpieces, and adjusted appropriately. In this it matters not whether reaching the specified number of workpieces collected is recognized by counting the individual workpieces collected or by measuring the time and taking into account the first machine cycle time. In the latter case the reaching of the specified number of workpieces collected can be recognized in a very simple manner, since the lapse of a time calculated as the mathematical product of the specified number and the first machine cycle time is awaited.

In a particularly preferred embodiment of the invention it is provided that the second machine tool is changed from the idle mode to a working mode when the specified number of workpieces has been collected. Particularly preferably, the timing of the second machine tool is such that it returns to the working mode, with all its tool modules and secondary control units fully activated, when the first of the collected workpieces is supplied to or reaches the second machine tool. In this way the production process of the workpieces can be kept short and hence as efficient and inexpensive as possible.

According to a preferred embodiment of the invention it is provided that workpieces are supplied continually to the first machine tool, so that it is permanently in a working mode. In this way the overall processing time of the workpieces by the machine tool system is kept as short, and therefore as efficient as possible. At the same time this ensures the most inexpensive possible production.

Preferably, it is provided that the energy demand is a demand for electrical energy. Since the electrical energy demand usually accounts for most of the total energy demand in present-day machine tools, the invention is advantageously focused on this. Furthermore, the electrical energy demand can be measured and checked comparatively simply. In particular, the energy-efficient working point of the machine tool is not determined with reference to an energy demand based on gas, oil or coal.

It is also preferable to provide that the method is repeated for each machine tool whose machine cycle time is shorter than the first machine cycle time and which is process-technologically downstream from the first machine tool. This has the advantage that for each such machine tool of the machine tool system, the energy demand can be reduced in each case.

The invention also concerns a device for reducing the energy demand of a machine tool of a machine tool system such that the machine tool system comprises at least a first machine tool with a first machine cycle time and a second machine tool with a second machine cycle time, wherein the machine tool system comprises conveying means designed to supply identical workpieces sequentially in time for processing, first to the first and then to the second machine tool, and wherein the second machine cycle time is shorter than the first machine cycle time. The distinguishing characteristic of the device according to the invention is that it comprises counting means and collecting means, wherein the counting means are designed to count a predetermined number of workpieces processed by the first machine tool and the collecting means are designed to collect the predetermined number of workpieces before they can be delivered to the second machine tool. Thus, since the device according to the invention comprises the means for carrying out the method according to the invention, in combination with the method according to the invention it makes possible the advantages already described.

According to a preferred embodiment of the invention it is provided that the device also comprises control means, such that the control means are designed to read out the counting means, to control the collecting means and/or, when the specified number has been reached, to generate an electrical signal designed to change the second machine tool from its idling mode to a working mode. For example, the control means can be in the form of an electronic computer unit, in particular a microcontroller. Preferably, the electronic computer unit is linked on the data level to electronic storage means to which the electronic computer unit has reading and writing access. Since the control means change the second machine tool to its working mode by means of the electric signal, the second machine tool is advantageously already fully functional when it received the first of the collected workpieces for processing.

The activation and deactivation of the collecting means also preferably takes place by an electric signal from the control means to the collecting means. Since the control means reads the counting means, it can emit the electric signal to the collecting means as soon as the specified number has been reached.

In a preferred embodiment of the invention it is provided that the device also comprises signal transmission means, the signal transmission means being designed to emit the electric signal to a data transmission medium. In this way the signal generated by the control means can be emitted by the device and, for example, sent to the second machine tool by the data transmission medium. The signal transmission means can for example be in the form of a socket or a plug, and the data transmission medium can be in the form of a data cable. The data cable can preferably be electrically coupled to the signal transmission means by means of a plug or a socket.

According to a further preferred embodiment of the invention it is provided that the collection means comprise a workpiece gate or an individually controllable part-section of a conveyor belt. The workpiece gate can for example comprise an arm that can be raised and lowered, which in the lowered position mechanically blocks the delivery of the workpieces to the second machine tool, for example because it blocks the passage of the workpieces. In contrast, in the raised position the arm allows the workpieces to pass. Also preferably, the workpiece gate can comprise more than one arm that can be raised and lowered. Alternatively, the arm or arms of the workpiece gate can also be designed to pivot horizontally so that they can be swiveled into the path of the workpieces from the side in order to block them, and swiveled out again to open the delivery path of the workpieces. An individually controllable part-section of a conveyor belt can for example be switched off in order to interrupt the delivery of the workpieces to the second machine tool. In that case, for collecting the workpieces there is at the transition to the switched-off section a part-section upstream from the switched-off section, which is not switched off.

In another preferred embodiment of the invention it is provided that the counting means comprise a light-screen. By means of the light-screen the workpieces can be counted in a simple manner since the light-screen detects the number of workpieces that pass by it and these are counted by a counter such as an electronic computer unit. For that purpose a data connection between the light-screen and the counter or electronic computer unit is provided unless the counter or electronic computer unit is in any case integrated in the light-screen.

According to a further preferred embodiment of the invention it is provided that the device is designed to carry out the method according to the invention. This gives the advantages already mentioned.

In addition, the invention concerns a machine tool system, such that the machine tool system comprises at least a first machine tool with a first machine cycle time and a second machine tool with a second machine cycle time, wherein the machine tool system comprises conveyor means designed to supply identical workpieces sequentially in time for processing, first to the first and then to the second machine tool, and wherein the second machine cycle time is shorter than the first machine cycle time. The machine tool system is characterized in that the machine tool system comprises a device according to the invention.

Preferably it is provided that the machine tool system is designed to process the workpieces by cutting methods. Since the processing of workpieces by cutting is particularly energy-intensive, a comparatively large saving of energy can be achieved by designing the machine tool system in accordance with the invention.

Particularly preferably, it is provided that all of the at least two machine tools are designed to process the workpieces by cutting. Alternatively, however, it is possible and preferable for only one or some of the machine tools to be designed to process the workpieces by cutting.

In a preferred embodiment of the invention it is provided that the machine tool system is designed to process the workpieces by grinding and/or by milling and/or by turning. With such a design of the machine tool system particularly advantageous results have been obtained in relation to the possible energy savings.

A grinding process or a milling process or a turning process usually comprises a rough-machining stage followed by a finish-machining stage. The rough-machining stage involves the removal of material from the workpieces with comparatively large chip volumes. The rough-machining stage serves to bring the workpiece as close as possible to its final shape within the shortest possible time. Accordingly, rough-machining tools are usually tools with comparatively coarse teeth that operate with a large depth of cut. The rough-machining process as a rule produces a comparatively rough surface with not very great dimensional accuracy. In contrast, the exact and desired end shape of a workpiece is produced by the subsequent finish-machining process. Thus, finish-machining tools are usually essentially fine-toothed and operate with a comparatively smaller depth of cut, so that a comparatively smoother surface is achieved.

According to a further, particularly preferred embodiment of the invention it is provided that the machine tool system is designed to grind and/or mill gearwheel teeth. Since it is precisely the grinding or milling of gearwheel teeth that are particularly energy-intensive, there is in that context much potential for saving energy by designing the machine tool system in the manner described.

In a further preferred embodiment of the invention it is provided that the conveyor means are in the form of a conveyor belt. Conveyor belts are widely known, flexible and versatile means for transporting the most varied types of workpieces. Furthermore, they are comparatively inexpensive and robust.

### BRIEF DESCRIPTION OF THE DRAWINGS

Below, examples of the invention are explained with reference to embodiments illustrated in the drawings, which show:

FIG. 1: As an example and schematically, a possible embodiment of a device according to the invention,

FIG. 2: As an example and schematically, a possible embodiment of a machine tool system according to the invention, and

FIG. 3: An example embodiment of a method according to the invention, shown in the form of a flow chart.

### DETAILED DESCRIPTION OF THE PREFERRED EMBODIMENTS

The same objects, functional units and comparable components are denoted by the same indexes in all the figures. In relation to their technical features these objects, functional units and comparable components are designed identically unless indicated explicitly or implicitly in the description.

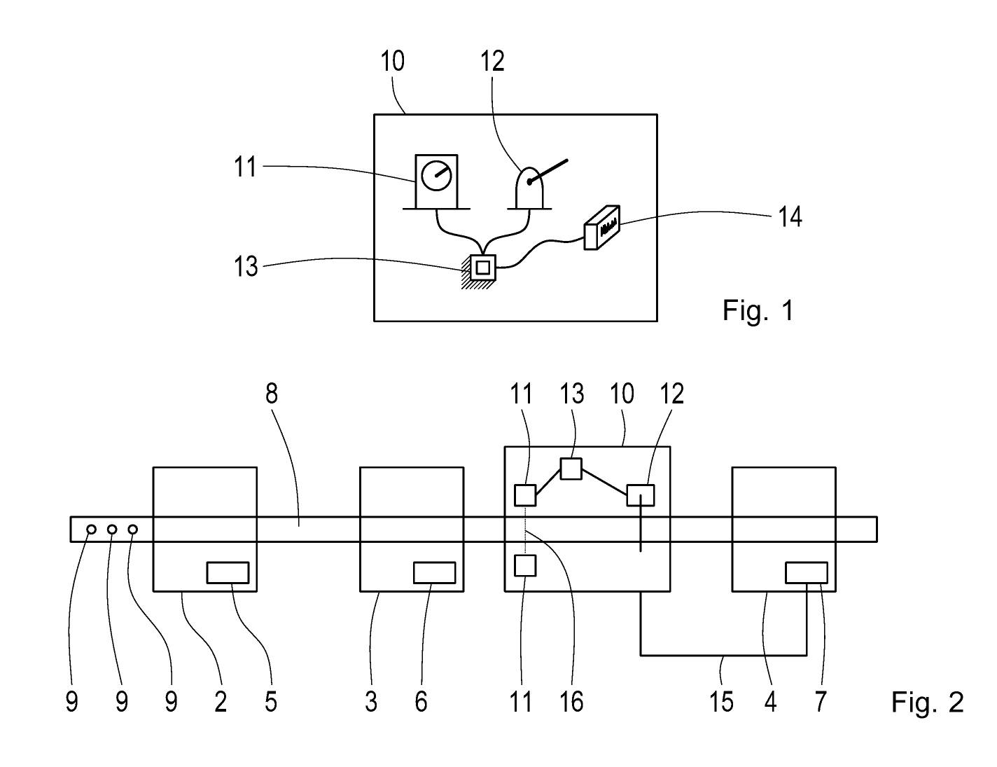

FIG. 1 shows, schematically and as an example, a device 10 according to the invention which comprises counting means 11, collecting means 12, control means 13 and signal transmission means 14. The counting means 11 in this example are in the form of a quartz oscillator based clock-pulse generator 11 whose pulse signals are a fixed time interval apart and are counted and summed by the control means 13. The control means 13, in turn, are in the form of a microcontroller 13. In this example the collecting means 12 are in the form of a workpiece gate 12 designed to interrupt the delivery of workpieces 9 to a downstream machine tool 2, 3 or 4 and to collect the workpieces 9 until a specified number of workpieces 9 has been reached. The reaching of the specified number of workpieces 9 is recognized in this example by the lapse of a time interval required for the specified number of workpieces 9 to be processed by an upstream machine tool 2, 3 or 4. In other words, the counting means 11 determine the time continuously and after the lapse of a specified time interval the control means 13 recognize that the specified number of workpieces 9 have been collected. As soon as the control means 13 recognize that the specified number of workpieces 9 have been collected, an electrical signal is emitted to the workpiece gate 12, which then releases the collected workpieces 9 to that they can be passed on by conveyor means 8 which do not belong to the device 10 and are not shown in FIG. 1. At the same time the control means 13 emit an electrical signal to the signal transmission means 14, which in this example is in the form of a socket for a plug of a data transmission medium 15. In this example the signal transmission means 14 consist of an RJ45-socket 14 and the plug of the data transmission medium 15 is an RJ45 plug, so that the data transmission medium is in the form of a network cable. The electrical signal sent by the control means 13 to the signal transmission means 14 is designed to change a machine tool 2, 3 or 4 from an idling mode to a working mode.

FIG. 2 schematically shows, as an example, a possible embodiment of a machine tool system 1 according to the invention. The machine tool system 1 shown as an example comprises three machine tools 2, 3 and 4. Each of the machine tools 2, 3 and 4 comprises a control unit, 5, 6 and 7 respectively, which in each case comprise in turn a plurality of subordinate, secondary control units (not shown) for the control and regulation of various tool modules (also not shown) of the machine tools 2, 3 or 4. The machine tool system 1 shown as an example also comprises conveyor means 8 in the form of a conveyor belt 8, on which workpieces 9 are arranged. In this example the workpieces 9 are all the same, i.e. identical workpieces 9 in the form of metallic cylinders. Sequentially in time, the workpieces 9 are conveyed first to the machine tool 2, then to the machine tool 3 and finally to the machine tool 4 for processing. The machine tool 2 has a machine cycle time of, for example, 20 s. This means that to process a workpiece 9 the machine tool 2 needs 20 s. The machine tool 2 is a furnace that heat treats the workpieces 9. When the machine tool 2 has finished processing a workpiece 9, the workpiece 9 is taken by the conveyor belt 8 to the machine tool 3. In this example the machine tool 3 carries out a milling operation on the workpiece 9 and for this has a machine cycle time of 25 s, meaning that it needs 25 s to process a workpiece 9. When the machine tool 3 has finished processing a workpiece 9, the workpiece 9 can be passed on by the conveyor belt 8 to the machine tool 4. In this example the machine tool 4 has a machine cycle time of 16 s, which means that the time taken by machine tool 4 to process a workpiece 9 is 16 s. In this example the machine tool 4 is a grinding machine which carries out a rough-machining and a finish-machining operation on the workpiece 9. Since the total processing time for a workpiece 9 by the machine tool system 1 in this example is characterized by the longest machine cycle time or corresponds to it, the total processing time amounts to 25 s. In this example the machine tool 3 now represents the first machine tool in the sense of the invention, whereas in the example the machine tool 4 represents the second machine tool in the sense of the invention. Since as described the machine cycle time of the machine tool 4 is 16 s and the machine cycle time of the machine tool 3 is 25 s, the second machine cycle time is shorter than the first machine cycle time. After the processing of a workpiece 9 by the machine tool 3, the workpiece 9 is conveyed by the conveyor belt 8 to a device 10 designed according to this example. The device 10 comprises a light-screen 11, a workpiece gate 12 and an electronic computer unit 13 that controls the light-screen 11 and detects its condition at the time. For this, with reference to the number of interruptions of the light beam 16 the electronic computer unit 13 counts the number of workpieces 9 that have been transported onward from the machine tool 3. The light-screen 11 represents the counting means 11, the workpiece gate 12 represents the collecting means 12 and the electronic computer unit 13 represents the control means 13. In this example the condition of the light-screen 11 can be “light beam 16 interrupted” and “light beam 16 not interrupted”. Each interruption of the light beam 16 indicates that a workpiece 9 has moved past the light-screen 11. The electronic computer unit 13 also controls the condition of the workpiece gate 12, which in this example has an arm that can be raised or lowered as a mechanical barrier. Thus, the condition of the workpiece gate 12 can be “open” or “closed”. Depending on the number of workpieces 9 collected and counted by the light-screen 11 and the electronic computer unit 13, the electronic computer unit 13 opens or closes the workpiece gate 12. In the open condition the workpieces 9 can move past the workpiece gate 12 whereas in contrast in the closed condition thereof the workpieces 9 cannot pass the workpiece gate 12 and are collected. During the collection of the workpieces 9 after they have been processed by the machine tool 3, the conveyor belt 8 is not stopped but continues moving regardless of the condition of the workpiece gate 12. Thus, the workpiece gate 12 is made correspondingly strong and load-bearing, in order to stand up to the conveying pressure produced by the conveyor belt 8 and the collecting of the workpieces, i.e. their retention. Thus the workpieces 9 remain on the conveyor belt 8 while the belt 8 continues moving and “slides away” under the retained workpieces 9. As soon as the light-screen 11 or the electronic computer unit 13 has counted a specified number of workpieces 9, in this example 17, the electronic computer unit 13 opens the workpiece gate 12 by transmitting a corresponding electrical signal so that the collected workpieces 9 can be conveyed together to the machine tool 4. At the same time the collecting means 12 emit by way of a signal transmission means 14 an electrical signal to a data transmission means 15, which passes the electrical signal on to the control unit 7 of the machine tool 4. The electrical signal switches the machine tool 4 out of its idling mode back to its working mode. Depending on the selected idling mode stage to which the machine tool 4 was previously changed, this takes up a certain time, for example 20 s. In that as described in this example the workpieces 9 are collected by the device 10, the related time duration of the idle mode of the machine tool 4, during which no workpieces 9 are present for processing in the machine tool 4, can be extended. In this example the time duration now amounts to 153 s. That duration is known, and is stored in the control device 7 of the machine tool 4. The control device 7 is designed to change the machine tool, depending on the situation, into the idle mode or into a special idling mode stage and back again into the working mode. Since the idle mode of the machine tool 4 is divided into a plurality of different idling mode stages, which can be selected in accordance with an expected duration of the idle mode, it is now possible starting from the known expected idle mode duration of 153 s to change the machine tool 4 to its standby mode stage. Here, the standby mode stage is that idle mode stage in which the power demand is comparatively the smallest, since in this example all the tool modules and most of the secondary control units are deactivated. But if the expected duration in the idle mode were shorter, then it would not be worth changing the machine tool 4 to the standby mode stage since due to the time taken to reactivate all the tool modules and secondary control units that were deactivated in the standby mode stage, the processing of the workpieces 9 would be delayed, which would extend the total processing time of the workpieces 9 to 28 s. That would affect efficiency and costs adversely.

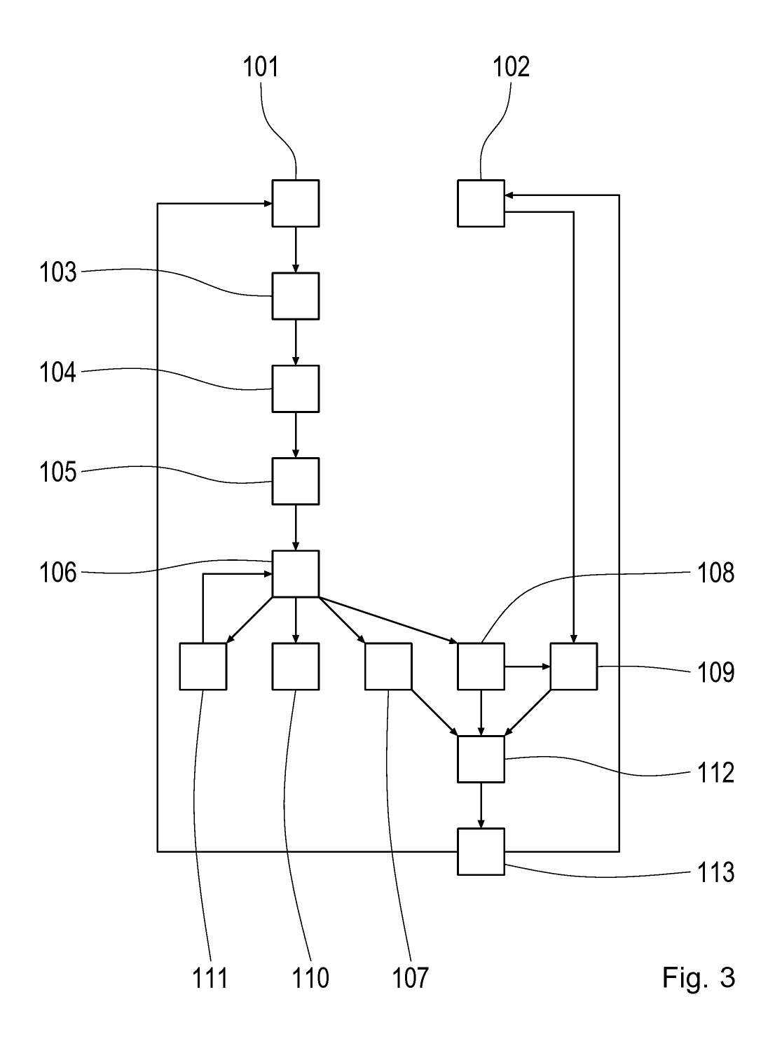

FIG. 3 shows an example embodiment of the method according to the invention, in the form of a flow chart. In process step 101 a workpiece 9 is processed by a first machine tool 3 with a first machine cycle time. At the same time as process step 101 a second machine tool 4 with a second machine cycle time is in an idle mode in step 102. The second machine cycle time is shorter than the first machine cycle time, which means that the first machine tool 3 takes longer to process a workpiece 9 than does the second machine tool 4. In process step 103 the processing of the workpiece 9 by the first machine tool 3 is completed and the workpiece 9 is taken away from the first machine tool 3 by the conveyor means 8. In the next process step 104 the workpiece 9 is counted by counting means 11 and in step 105 it is collected by collecting means 12 before, as the process continues, it is transported to the second machine tool 4. In step 106 the counting and collecting means 11 and 12 count and collect further workpieces 9 until a specified number of workpieces 9 have been counted and collected. When the specified number of workpieces 9 have been counted and collected, then in step 107 the collecting means 12 are first instructed by an electrical signal not to collect any more workpieces 9 and to allow the conveyor means 8 to transport the collected workpieces 9 to the second machine tool 4. At the same time, in step 108 an electrical signal is sent to the second machine tool 4 which, in step 109, changes the machine tool from its idle mode to the working mode. Also at the same time as the steps 107 and 108, in step 110 the counting means 11 are reset so that they can again count the workpieces 9 processed by the first machine tool 3, starting from zero. But if in step 111 the specified number of workpieces 9 have not yet been counted or not yet been collected, then the process described in this example is repeated from step 106 onward. In process step 112 the collected workpieces 9 are now processed by the second machine tool 4. Once the processing of the collected workpieces 9 by the second machine tool 4 has been completed, in step 113 the second machine tool 4 is returned to its idle mode and the process described as an example begins again at step 101 or 102.

### INDEXES

1 Machine tool system
2 Machine tool
3 Machine tool
4 Machine tool
5 Control unit of machine tool 2
6 Control unit of machine tool 3
7 Control unit of machine tool 4
8 Conveyor means, conveyor belt
9 Workpiece
10 Device
11 Counting means, light-screen, pulse emitter
12 Collecting means, workpiece gate
13 Control means, microcontroller
14 Signal transmission means, RJ45 socket
15 Data transmission means
16 Light beam
101 Processing of a workpiece by the first machine tool
102 Second machine tool is in its idle mode
103 Completion of the processing of the workpiece by the first machine tool
104 Counting of the workpiece
105 Collection of the workpiece
106 Counting and collection of further workpieces
107 Transport of the collected workpieces to the second machine tool
108 Emission of an electrical signal to the second machine tool
109 Change of the second machine tool to its working mode
110 Resetting of the counting means
111 Counting and collection of further workpieces
112 Processing of the collected workpieces by the second machine tool
113 Changing the second machine tool to its idle mode

1-16. (canceled)

17. A method of reducing an energy demand of a machine tool (2, 3, 4) of a machine tool system (1) having at least a first machine tool (3), with a first machine cycle time, and a second machine tool (4), with a second cycle time, the method comprising:
processing (101, 107) identical workpieces (9) sequentially in time first with the first machine tool (3) and then with the second machine tool (4), with the second machine cycle time being shorter than the first machine cycle time, and
collecting (105, 106) the workpieces (9) after processing by the first machine tool (3) and before being transported (107) to the second machine tool (4).

18. The method according to claim 17, further comprising, when the second machine tool does not have any workpieces (9) for processing, changing the second machine tool (4) to an idle mode (113).

19. The method according to claim 18, further comprising dividing the idle mode into a plurality of idling mode stages, and when changing to the idle mode, one of the plurality of idling mode stages is selected in accordance with an expected duration of the idle mode.

20. The method according to claim 17, further comprising collecting a specified number of the workpieces (9) processed by the first machine tool (3).

21. The method according to claim 20, further comprising changing the second machine tool (4), from the idle mode to a working mode (109), once the specified number of the workpieces (9) are collected.

22. The method according to claim 17, further comprising continually transporting the workpieces (9) to the first machine tool (3) such that the first machine tool is in a continuous working mode.

23. A device (10) for reducing an energy demand of a machine tool (2, 3, 4) of a machine tool system (1) having at least a first machine tool (3), with a first machine cycle time, and a second machine tool (4), with a second machine cycle time, the machine tool system (1) having a conveyor (8) designed to transport identical workpieces (9) sequentially in time for processing, first to the first machine tool (3) and then to the second machine tool (4), and the second machine cycle time being shorter than the first machine cycle time, the device comprising:
a counter (11) for counting a specified number of workpieces (9) processed by the first machine tool (3); and
a collector (12) for collecting the specified number of workpieces (9) processed by the first machine tool (3) before the workpieces are conveyed to the second machine tool (4).

24. The device (10) according to claim 23, wherein the device (10) comprises a controller (13) for reading the counter (11), the controller controlling the collector (12) and, when the specified number is reached, the controller producing an electrical signal designed to change the second machine tool (4) from an idle mode to a working mode.

25. The device (10) according to claim 24, wherein the device (10) also comprises a signal transmission means (14), and the signal transmission means (14) is designed to send the electrical signal to a data transmission medium (15).

26. The device (10) according to claim 24, wherein the collector (12) comprise either a workpiece gate (12) or an individually controllable part-section of the conveyor (8).

27. The device (10) according to claim 24, wherein the counter (11) comprise a light-screen (11).

28. The device (10) according to claim 24, wherein the device (10) is designed to carry out a method for reducing an energy demand of the machine tool (2, 3, 4) of the machine tool system (1), the method including: processing (101, 107) the identical workpieces (9) sequentially in time first with the first machine tool (3) and then with the second machine tool (4); and collecting (105, 106) the workpieces (9) after being processed by the first machine tool (3) but before being transported (107) to the second machine tool (4).

29. A machine tool system (1) comprising:
at least a first machine tool (3) with a first machine cycle time;
a second machine tool (4) with a second machine cycle time;
a conveyor (8) for transporting identical workpieces (9) sequentially in time for processing, first to the first machine tool (3) and then to the second machine tool (4), and the second machine cycle time being shorter than the first machine cycle time;
a device (10) for reducing an energy demand of at least one of the first and the second machine tools (2, 3, 4), the device having a counter (11) for counting a specified number of workpieces (9) processed by the first machine tool (3), and a collector (12) for collecting the specified number of workpieces (9) processed by the first machine tool (3) before the workpieces are conveyed, via the conveyor, to the second machine tool (4).

30. The machine tool system (1) according to claim 29, wherein the machine tool system (1) is designed to process the workpieces (9) by at least one of grinding, milling and turning.

31. The machine tool system (1) according to claim 30, wherein the machine tool system (1) is designed to at least one of grind and mill gearwheel teeth.

32. The machine tool system (1) according to claim 29, wherein the conveyor (8) is a conveyor belt.
